(19) United States
(12) Patent Application Publication
(10) Pub. No.: US 2017/0061824 A1
(43) Pub. Date: Mar. 2, 2017

(54) BILINGUAL BLOCKS, APPLICATION, AND SYSTEM

(71) Applicant: Pepe Loves Books, Inc., Miami Beach, FL (US)

(72) Inventor: Marilu KERNAN, Miami Beach, FL (US)

(73) Assignee: Pepe Loves Books, Inc., Miami Beach, FL (US)

(21) Appl. No.: 15/251,686

(22) Filed: Aug. 30, 2016

Related U.S. Application Data
(60) Provisional application No. 62/212,666, filed on Sep. 1, 2015.

(51) Int. Cl. G09B 19/06; A63H 33/04; G06F 3/044; G09B 5/02; G06F 3/041; G06F 3/0354

(52) U.S. Cl. CPC G09B 19/06; G06F 3/0416; G06F 3/0354; G06F 3/044; G09B 5/02; A63H 33/042

(57) ABSTRACT

Systems and methods described herein may display data based on interactions between blocks and a touchscreen device. For example, a device comprising a touchscreen and a processor may detect a block interfacing with the touchscreen. The device may identify the block based on at least one element disposed on a surface of the block. The device may select a program for display on the touchscreen based on an identity of the block determined by the identifying and display the selected program.

### CROSS-REFERENCE TO RELATED APPLICATION

This application claims priority from U.S. Provisional Application No. 62/212,666, entitled “BILINGUAL BLOCKS, APPLICATION AND SYSTEM,” filed Sep. 1, 2015, the entirety of which is incorporated by reference herein.

### SUMMARY OF THE DISCLOSURE

The disclosed embodiments relate to and provide an educational system for creating a bilingual learning experience for the user (e.g., a child).

The disclosed embodiments may provide a unique set of blocks, having a similar appearance to traditional children's alphabet and number blocks, yet designed to activate a touchscreen such as the touchscreen used on, e.g., a smartphone or tablet (hereinafter a “touchscreen device”). An application running on the touchscreen device may detect when one of the disclosed blocks has been placed on the touchscreen and may determine if a game and/or story designed for bilingual learning should be initiated. The game and/or story may be interactive, and the user's progress may be monitored, stored, and displayed if desired.

### BRIEF DESCRIPTION OF THE DRAWINGS

FIGS. 1-3, 7, 10A, 10B, and 11 are perspective views of a block according to an embodiment of the invention.

FIGS. 4-5 show a touchscreen device running an application according to an embodiment of the invention.

FIG. 6 shows a method for processing block inputs at a touchscreen device according to an embodiment of the invention.

FIGS. 8 and 9 are perspective views of a plurality of blocks according to an embodiment of the invention.

FIGS. 12A-16B are perspective views of block components according to an embodiment of the invention.

### DETAILED DESCRIPTION OF SEVERAL EMBODIMENTS

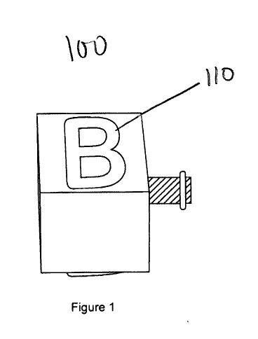

FIGS. 1-3 are perspective views of a block 100 according to an embodiment of the invention. In one embodiment, the disclosed blocks 100 may be made of a soft plastic material for easy handling and to prevent damage to the touchscreen device. As shown in FIG. 1, one side of the block 100 may have a letter/number 110 on it. The letter/number 110 may be in a bold color that contrasts with the color of the block's 100 side (or the entire block 100) to emphasize the correct look of that letter or number 110. The letter/number 110 may be raised above the surface of the block 100, even with the surface of the block 100, or recessed below the surface of the block 100. Hereinafter, the side of the block 100 with the letter/number 110 will be referred to as the front side of the block.

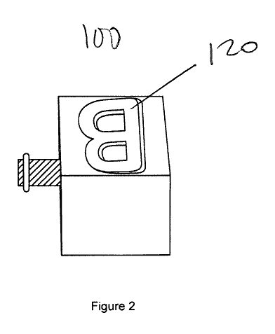

FIG. 2 shows a side of the block 100 opposite the front side. Hereinafter, this side of the block 100, opposite the front side of the block, will be referred to as the backside of the block 100. As shown in FIG. 2, in one embodiment the back of the block 100 may contain the same letter/number 120 except that this letter/number 120 may be raised above the surface of the block's side. Moreover, the letter/number 120 may be backwards (i.e., reversed in comparison to the letter/number 110 on the front side of the block 100) and in a color that matches the backside of the block 100 so as to not make the letter/number 120 easily visible to the user's eye. Accordingly, a user may be able to easily judge which side of the block 100 is the front and which side is the back.

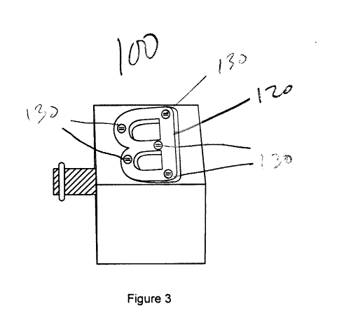

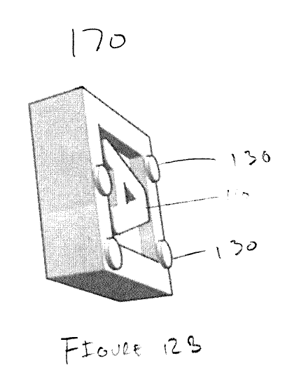

In one embodiment, the reversed raised letter/number 120 on the backside of the block 100 may be made of or contain a capacitive material such as e.g., capacitive silicon. The side that contains the raised letter 120 with the capacitive material may be configured to activate a portion of a touchscreen under control of an application (discussed below) running on the touchscreen device (e.g., smartphone, tablet). Alternatively, and as shown in FIG. 3, the reversed letter/number 120 can have “buttons” or “islands” 130 of capacitive material that may be flush with and/or raised above the bottom surface of the raised letter/number 120 and placed in one or more locations on the raised letter/number 120. That is, in this alternative embodiment, buttons 130 for each letter and number 120 may be uniquely configured so that each different letter and number 120 has a different button 130 configuration. Thus, the letter/number 120 may activate a portion of the touchscreen and be detected and identified by the application program running on the touchscreen device. FIG. 11 shows an alternative arrangement to FIG. 3, wherein buttons 130 are located on the block 100 but not on the letter 120 itself. Again, buttons 130 for each letter and number 120 may be uniquely configured so that each different letter and number 120 has a different button 130 configuration. In either case, raised buttons 130 may be aligned so that when backside of block 100 is resting on a surface, block 100 may resist wobbling.

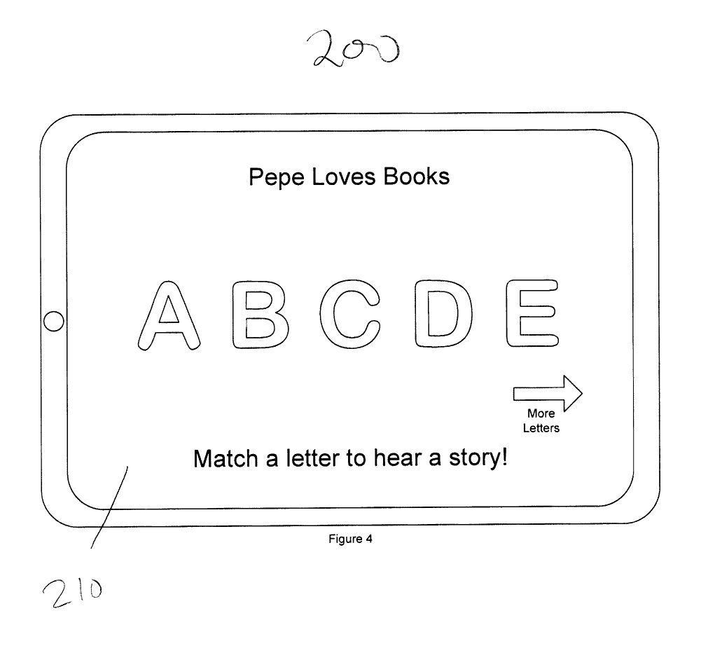

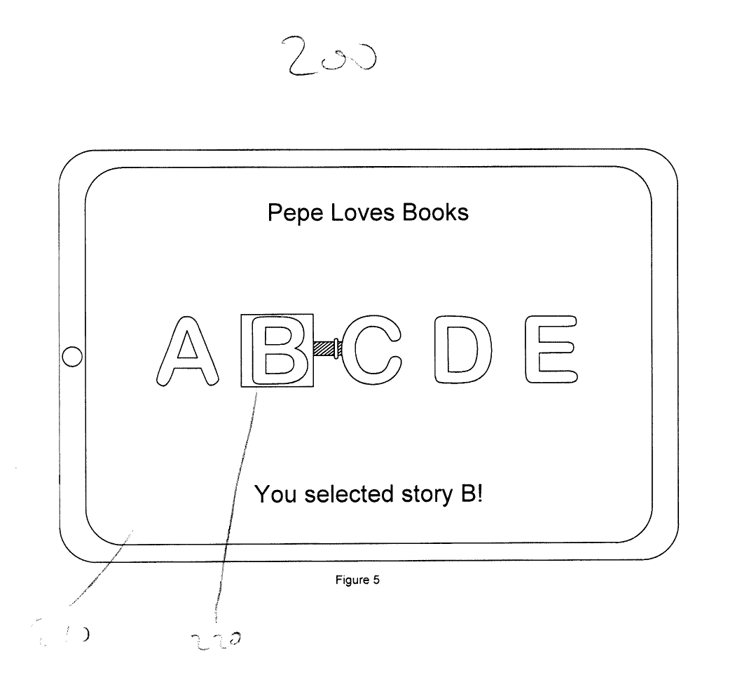

FIGS. 4 and 5 show a touchscreen device 200 running an application according to an embodiment of the invention. The capacitive material's shape (i.e., FIG. 2) or buttons (i.e., FIG. 3), which are unique for each letter and number, may be coded into the application disclosed herein (referred to generally as the “bilingual blocks mobile application”). Placement of the capacitive side of the block 100 (i.e., the backside of the block) on the touchscreen 210 when the application is active (see placement 220) may trigger a story and/or a game that entertains and educates the child on that particular letter or number in multiple languages.

Each letter in the alphabet may trigger pre-programmed stories and games in the application—for example one in English and one in Spanish. Some letters (e.g., Spanish letter “Ñ”) may only have Spanish stories and games. In one embodiment, there will be 27 alphabet blocks 100 (i.e., A through Z and “Ñ”) and ten number blocks 100 (i.e., 0 through 9). Users (e.g., children) interacting with the bilingual blocks mobile application may learn letters/words/numbers and hear pronunciations of those letters/words/numbers in both English and in Spanish along with experiencing and interacting with stories and games. In some embodiments, other languages may be supported by the blocks 100. For example, other languages using the ISO basic Latin alphabet may be supported by the same set of blocks 100 described above. Other blocks 100 may include other characters such as Chinese symbols or the like. Additionally, blocks 100 may include numbers, lower case letters, punctuation, and/or other symbols.

It is expected that the disclosed blocks can be used for toddlers starting at age 18 months and that there will be age appropriate bilingual blocks mobile application stories and games for children up to the age of 5. It should be appreciated, however, that the disclosed embodiments should not be limited to any age or type of user and that the principles disclosed herein can be applied to blocks, stories, and/or games for any user, even adults. It should also be appreciated that other symbols may be applied to blocks 100 and may be used to trigger different content on the touchscreen device 200.

In one embodiment, the stories/games may be character and story-based to keep the user, particularly a child, engaged and entertained. In one embodiment, the characters are based on the “Pepe Loves Books” series of books created and published by Pepe Loves Books, LLC. In this embodiment, Pepe and his friends serve as characters in the stories and as learning guides or characters in the games.

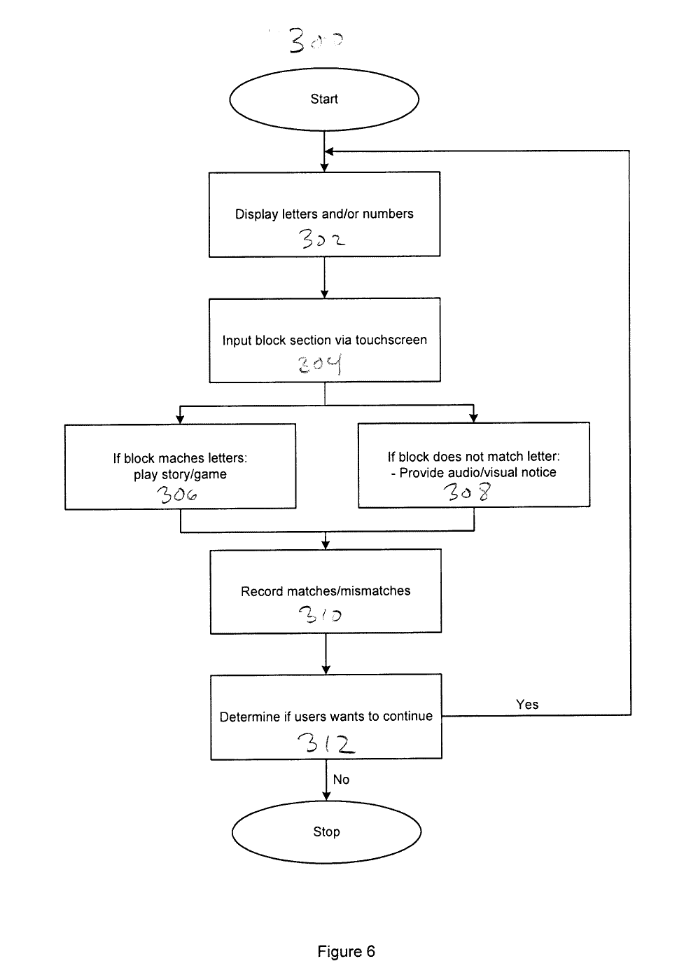

As can be appreciated, to operate the bilingual blocks mobile application, it may first be installed on the touchscreen device 200. Games or stories may be included with the application and/or downloaded separately onto the device 200. Once installed, the application may be activated, causing a process similar to the one illustrated in FIG. 6 to begin on the device, as described below. Moreover, parents may have access through the same or a different application to lessons on how to encourage their child's learning using the disclosed blocks and application.

In one embodiment, the above described application may be implemented in software (i.e., computer instructions) that are stored in a computer readable memory and executed by a processor within the touchscreen device 200. The touchscreen device, therefore, may comprise a touchscreen display 210, processor, and memory and may include other features such as wireless and wired communications mechanisms for communicating over a network (e.g., the Internet) or for cellular-type communications (e.g., 4G), to name a few. The device 200 under the control of the application, the application, and the blocks 100 may form a bilingual learning and entertainment system incorporating the principles disclosed herein.

In one embodiment, as shown in FIGS. 4-6, the game and/or story may be triggered when the application detects that there is contact between the letter/number 120 on the backside of the block 100 at a point on or substantially near a matching letter/number being displayed on the touchscreen 210. Device 200 may select a specific game/story based on the specific block placed on touchscreen 210. Alternatively, the game and/or story maybe triggered when the application detects that there is contact between any letter/number 120 on the backside of the block 100 at any point/position on the touchscreen 210. This may be an option set by the user (or the user's parent) such as a level of difficulty option or age level option, to name a few.

FIG. 6 shows an example method 300 for processing block 100 inputs at a touchscreen device 200 according to an embodiment of the invention. Blocks 100 may interact with device 200 to create auditory/visual learning/entertainment experiences. In 302, device 200 may display one or more letters and/or numbers on the touchscreen 210. A user may place the backside of a block 100 on the touchscreen 210. In 304, device 200 may detect the block 100, and application may input the code associated with the block 100 and determine if the block 100 has been placed on a matching letter/number. Physically placing the bottom of block 100 on touchscreen 210 may trigger the interaction in one of various ways. In one example, touchpoints may be coded using an algorithm based on touchpoint distances between one another and a series of mathematical formulas coded to prevent false positives balanced with high responsivity. In another example, pressure on the screen caused by the shape of the letter/number or other image on block 100 may provide the input. In another example, an image on block 100 may be read by touchscreen 210. Detecting block 100 may include determining, based on the encoded information in the touchpoint distances or other information sensed by touchscreen 210 (e.g., shape, pressure, image, etc.), which specific block 100 is placed on touchscreen 210. In 305, if the block 100 has been placed on a matching letter/number, a story and/or game matching the specific block 100 may be started on the device 200.

If, however, it has been determined that the block 100 has not been placed on a matching letter/number, in 308, the application may display an audible and/or visual indicator/alert to notify the user that a story/game will not be initiated because of the mismatch. The user may be prompted to continue using the application, causing the application to input the next block 100 selection, or to exit the application.

As noted above, the story/game may be interactive, requiring the user to match the block's letter/number again during the course of interacting with the story/game. For these types of stories/games, in 310, the application may record matches and mismatches, which may be used to monitor the user's learning progress on specific letters and numbers. The user's progress may be displayed by the application or accessed via a menu if desired. In some embodiments, the games and stories may be designed to increase in difficulty based on the user's progress.

In 312, after a game or story has been completed, the application may determine whether the user would like to continue (e.g., by receiving a command to play again or the like). If so, process 300 may repeat. If not, process 300 may end.

In some embodiments, the front side of the block 100 may have a letter/number 110 in a bold color with a color that contrasts the background. This may be the side of the block that is visible to the child when she/he places the block 100 on the mobile device. The opposite side of the block 100 may have a letter/number 120 in the block's 100 background color so that it blends in with (and does not contrast) with the background color. This may make it less likely for the user to recognize or become confused with the reversed letter/number 120 on the backside of the block 100.

The blocks 100 may be designed to meet United States' standards for infants and toddlers in both size (to prevent choking) and in material safety (non-toxic). The blocks 100 may also serve as a standalone educational toy. Infants, toddlers, and preschoolers may use the blocks 100 as a toy in sand or in play dough since the reverse raised letter on the backside of the blocks 100 may create a right-side (i.e., correctly oriented) imprint in a soft pliable environment. The disclosed bilingual blocks 100 may also be stackable and may be used in other traditional alphabet block learning exercises. In some embodiments, blocks 100 may float on water.

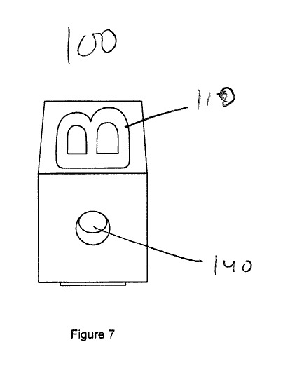

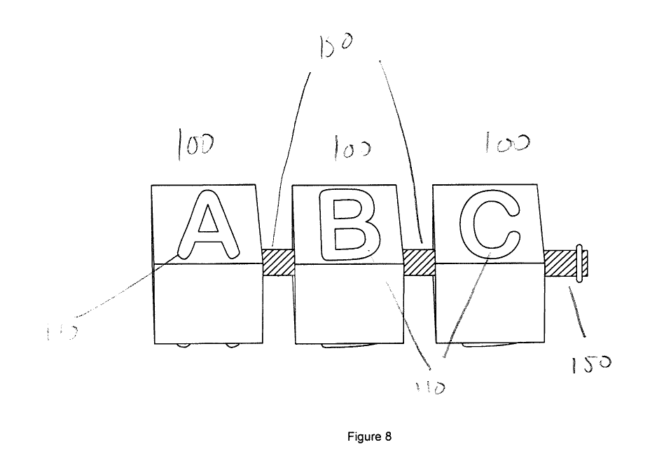

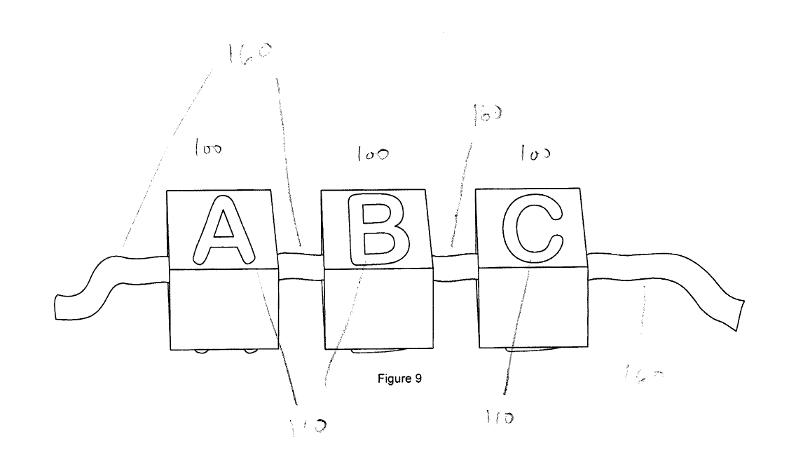

Moreover, as shown in FIGS. 1-3, 7, and 8, the disclosed blocks 100 may be linked together via peg-like male/female linking system. That is, as shown in FIGS. 1 and 8, one side of a block 100 may have a peg 150 or similar type of protrusion while another side of the block 100 may have a hole 140 sized to accept a peg/protrusion 150 from a different block 100 (see FIG. 7). Blocks 100 may be connected together as shown in FIG. 8. In addition, the peg/protrusion 150 may include a band or stopping element that causes some friction when a peg 150 is inserted into a hole 140, requiring a force to connect and disconnect blocks 100. This may keep the blocks 100 together until the user decides to separate them.

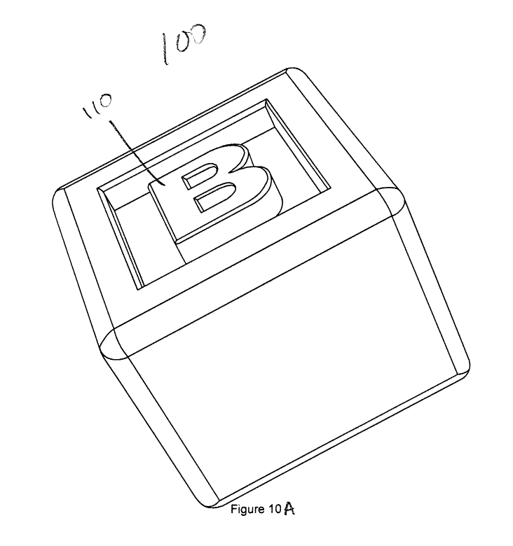

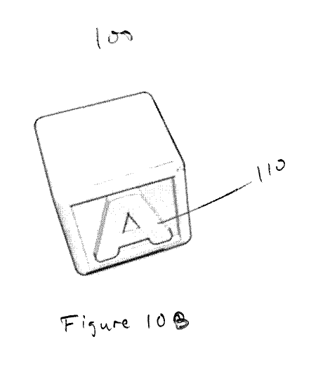

In another embodiment, a block may have two holes 140 therein. A string, rope, or other type of flexible member 160 may be inserted through the holes 140 to string blocks 100 together as shown in FIG. 9.

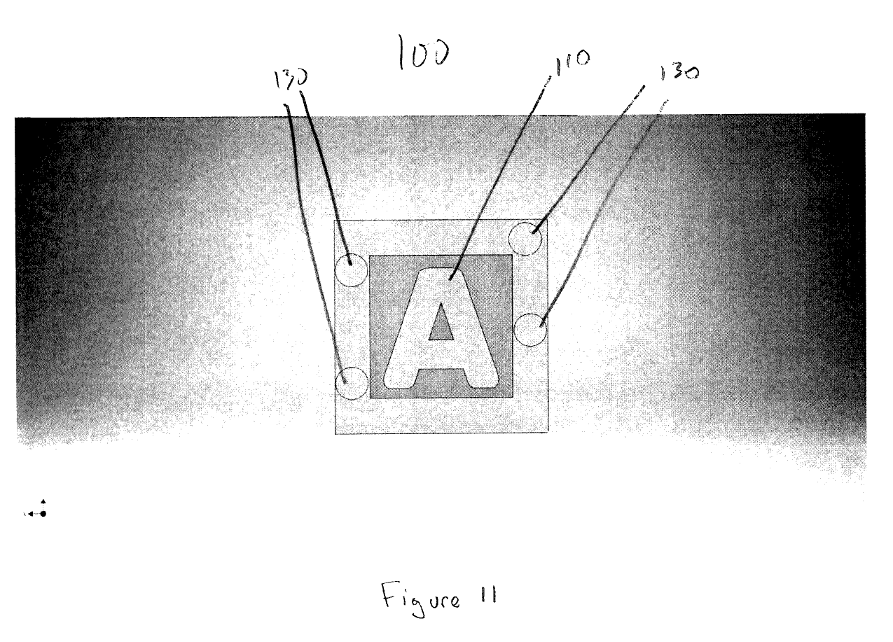

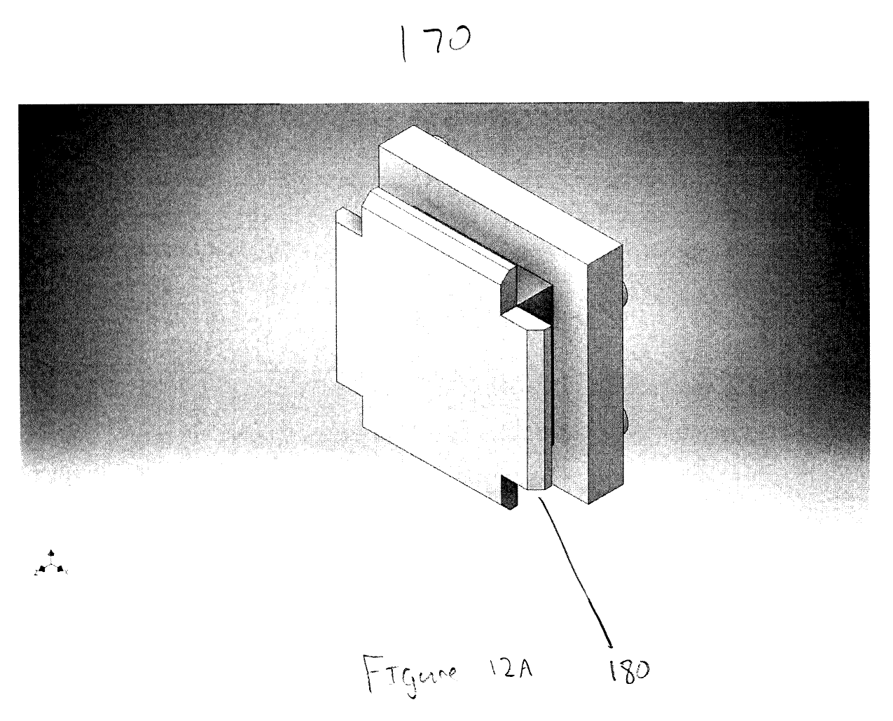

In another embodiment, each block 100 may comprise a border region formed around the front side and the back side of the block 100. FIG. 10 illustrates a front side of a block 100 comprising a border on the periphery of the front side. The border as well as the letter B may be raised above the surface of the remaining portion of the front side of the block 100. In some embodiments, the backside of the block 100 may include the same border and raised letter/number. The border may provide a traditional, nostalgic look to the block 100 and a space/portion to place capacitive substance areas (e.g., on the backside of the block 100) that may be used in identifying the letter through contact with touchscreen 210 as discussed above.

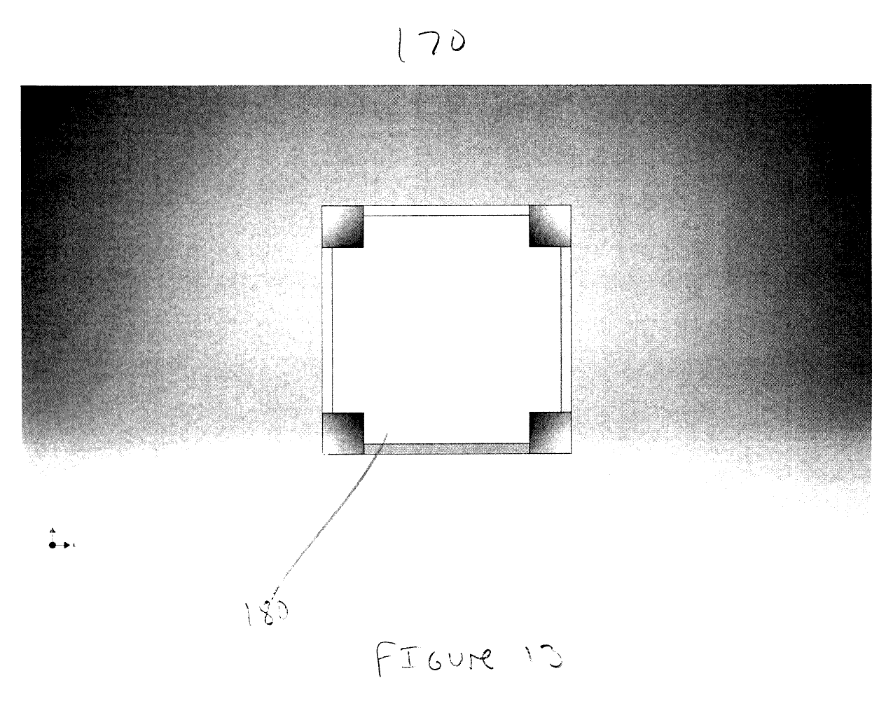

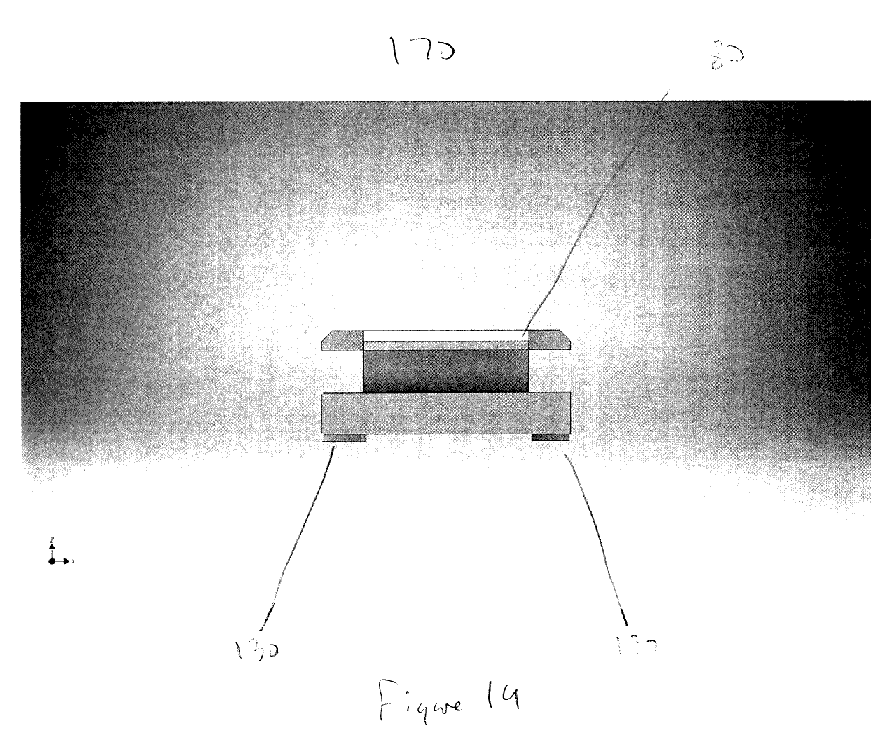

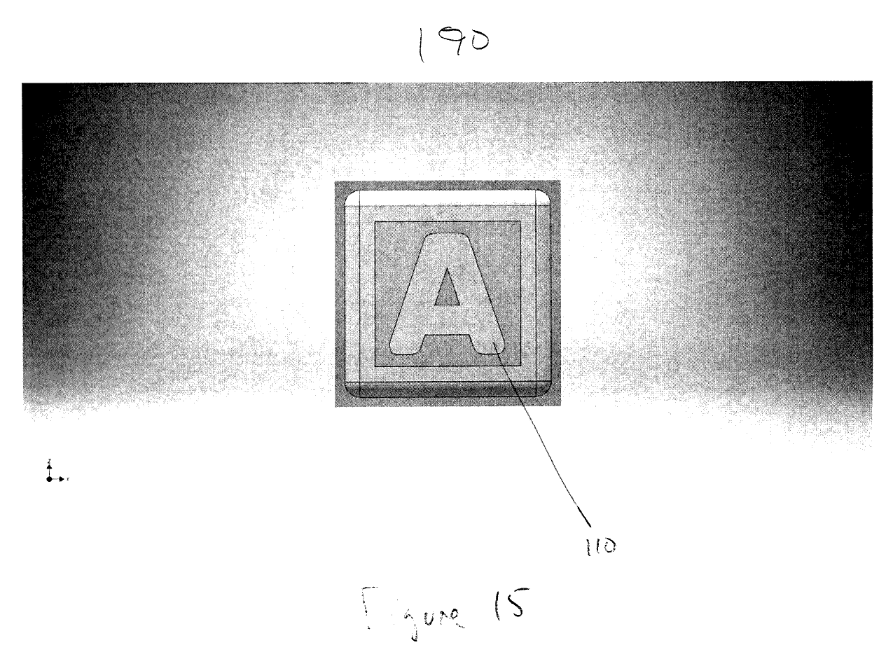

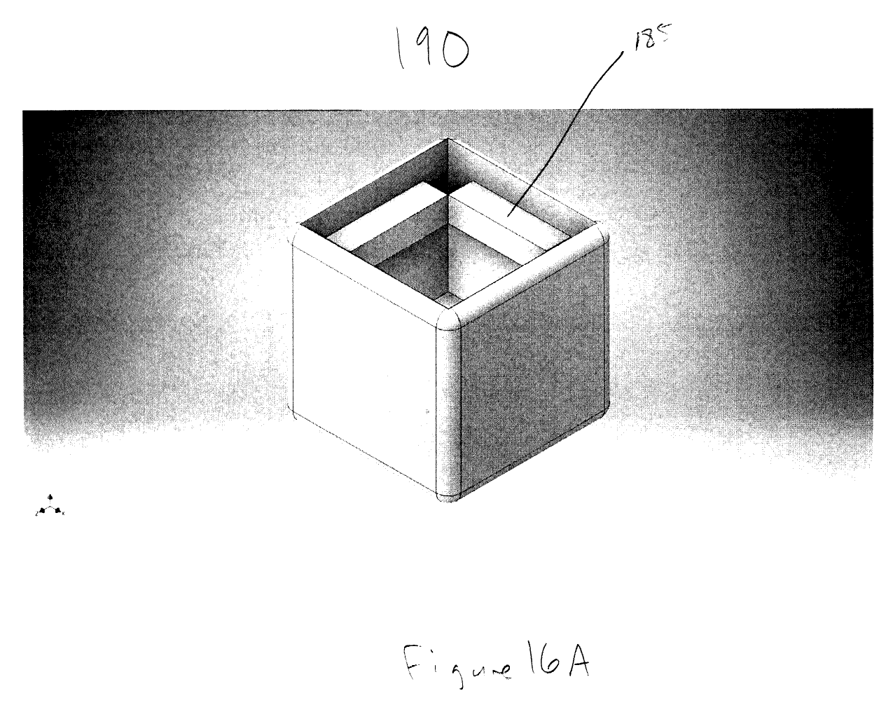

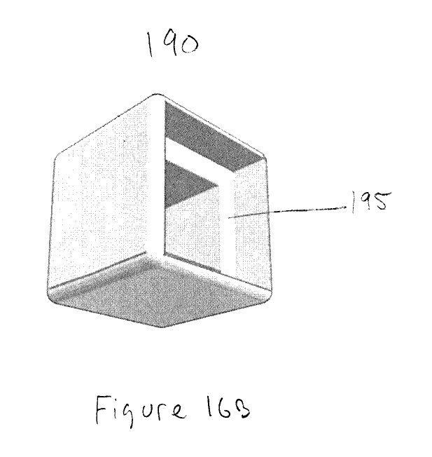

FIGS. 12A-16B are perspective views of block 100 components according to an embodiment of the invention. FIGS. 12A, 13, and 14 show a block panel 170 with tab 180. The front of panel 170 may be configured as shown in FIG. 11, for example, with buttons 130 disposed on an outer surface. Tab 180 may project from an inner surface of panel 170. FIG. 12B shows an alternative embodiment wherein block panel 170 has no tab 180. FIGS. 15 and 16A show a block body 190. Letter 110 may be disposed on one side of block body 190. Block body 190 may be substantially hollow, and tab(s) 185 may be disposed within the hollow area to engage with tab 180 of panel 170. When panel 170 is inserted in body 190, the respective tabs 180 and 185 may engage to secure panel 170 to body 190 and form a complete block 100. FIG. 16B shows an alternative embodiment, compatible with block panel 170 of FIG. 12B, wherein body 190 has a shelf 195 instead of tabs 185. Panel 170 may be inserted into body 190 and coupled to body 190 using an adhesive, for example. These configurations may allow the portion of block 100 with conductive surfaces to be manufactured separately from the rest of block 100.

It should be appreciated that, while the disclosed principles have been described using capacitive material for activating touchscreens operating on capacitive principles, the disclosed principles may be applied to touchscreens and similar devices that operate using other touch sensing principles such as e.g., resistive or mechanical sensing principles. Moreover, the disclosed principles may be used with screen-based input devices using multi-touch, pressure-sensitive technology such as e.g., the Sensel Morph. In that case, force/pressure on the device may be used to input the user's block and other selections.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
detecting, by a device comprising a touchscreen and a processor, a block interfacing with the touchscreen;
identifying, by the device, the block based on at least one element disposed on a surface of the block;
selecting, by the device, a program for display on the touchscreen based on an identity of the block determined by the identifying; and
displaying, by the device, the selected program.

2. The method of claim 1, wherein the at least one element comprises at least one capacitive surface.

3. The method of claim 2, wherein the at least one capacitive surface is formed in the shape of a symbol.

4. The method of claim 2, wherein the at least one capacitive surface comprises a plurality of capacitive buttons arranged in a pattern.

5. The method of claim 1, wherein the identifying comprises:
detecting a physical configuration of the at least one element; and
correlating the physical configuration with the identity of the block.

6. The method of claim 1, wherein:
the block comprises a symbol displayed on the surface; and
the identity of the block corresponds to the symbol.

7. The method of claim 1, wherein the program comprises a game and/or a story corresponding to the identity of the block.

8. A system comprising:
a block comprising a surface and at least one element disposed on the surface; and
a device comprising a touchscreen and a processor and configured to:
detect the block interfacing with the touchscreen;
identify the block based on the at least one element;
select a program for display on the touchscreen based on an identity of the block determined by the identifying; and
display the selected program.

9. The system of claim 9, wherein the at least one element comprises at least one capacitive surface.

10. The system of claim 10, wherein the at least one capacitive surface is formed in the shape of a symbol.

11. The system of claim 10, wherein the at least one capacitive surface comprises a plurality of capacitive buttons arranged in a pattern.

12. The system of claim 9, wherein the device is configured to identify the block by a process comprising:
detecting a physical configuration of the at least one element; and
correlating the physical configuration with the identity of the block.

13. The system of claim 9, wherein:
the block comprises a symbol displayed on the surface; and
the identity of the block corresponds to the symbol.

14. The system of claim 9, wherein the program comprises a game and/or a story corresponding to the identity of the block.

15. A block comprising:
a first surface comprising a symbol; and
a second surface comprising the symbol and at least one capacitive surface configured to communicate an identity of the block corresponding to the symbol to a touchscreen.

16. The block of claim 15, wherein the at least one capacitive surface is formed in the shape of the symbol.

17. The block of claim 15, wherein the at least one capacitive surface comprises a plurality of capacitive buttons arranged in a pattern.

18. The block of claim 15, wherein the symbol on the second surface is formed in a mirror image to the symbol on the first surface.

19. The block of claim 15, further comprising at least one connector configured to connect the block to another block.

20. The block of claim 15, wherein the block comprises:
a first part comprising the first surface; and
a second part comprising the second surface;
wherein the first part and second part are joined together to form the block.
